(19) United States
(12) Patent Application Publication
(10) Pub. No.: US 2010/0272853 A1
(43) Pub. Date: Oct. 28, 2010

(54) Method of Increasing the Milk and/or Meat Quantity of Silage-Fed Animals

(75) Inventors: Annette Freund, Limburgerhof (DE); Egon Haden, Ludwigshafen (DE); Jerry Minore, Cary, NC (US); Paul M. Vassalotti, Cross Plains, WI (US); Thomas Garfield, Research Triangle Park, NC (US); Jim Vandecoevering, Eagel, ID (US); Charles Rice, Research Triangle Park, NC (US); Gary Fellows, Apex, NC (US)

Correspondence Address: BRINKS, HOFER, GILSON & LIONE, P.O. BOX 1340, MORRISVILLE, NC, 27560, US

(73) Assignee: BASF SE, Ludwigshafen (DE)

(21) Appl. No.: 12/808,258

(22) PCT Filed: Dec. 16, 2008
(86) PCT No.: PCT/EP2008/067609

§ 371 Date: Jun. 15, 2010

(30) Foreign Application Priority Data
Dec. 21, 2007 (EP) 07123997.4

(51) Int. Cl. A23K 1/18; A23K 1/00

(52) U.S. Cl. 426/2; 426/636

(57) ABSTRACT

The present invention relates to a method of increasing the milk and/or meat quantity of silage-fed animals comprising the steps: a) treating plants and/or propagules and/or sites where the plants are growing or are to grow with at least one strobilurin compound b) producing silage from the plants treated according to step a) c) feeding the milk and/or meat producing animals with the silage produced according to step b) made from the plants treated according to step a). Furthermore, the present invention relates to silage for feeding animals, produced from plants treated with at least one strobilurin compound prior to producing said silage. In addition, the present invention relates to the use of at least one strobilurin compound to increase the milk quantity of silage-fed milk-producing animals. Moreover, the present invention relates to the use of at least one strobilurin compound to increase the meat quantity of silage-fed meat-producing animals.

The present invention relates to a method of increasing the milk and/or meat quantity of silage-fed animals comprising the steps:

a) treating plants and/or propagules and/or sites where the plants are growing or are to grow with at least one strobilurin compound
b) producing silage from the plants treated according to step a)
c) feeding the milk and/or meat producing animals with the silage produced according to step b) made from the plants treated according to step a).

In one embodiment, the invention relates to a method of increasing the milk quantity of silage-fed milk-producing animals comprising the steps a) to c) wherein in step c) the silage is fed to milk producing animals.

In another embodiment, the invention relates to a method of increasing the meat quantity of silage-fed meat-producing animals comprising the steps a) to c) wherein in step c) the silage is fed to meat producing animals.

Furthermore, the present invention relates to silage for feeding animals, produced from plants treated with at least one strobilurin compound prior to producing said silage.

In addition, the present invention relates to the use of at least one strobilurin compound for increasing the milk quantity of silage-fed milk producing animals.

Moreover, the present invention relates to the use of at least one strobilurin compound for increasing the meat quantity of silage-fed meat producing animals.

Today, the production of milk and meat takes place in an industrial scale. Milk and meat are regarded to be an essential part of healthy human nutrition. In addition, milk can also be processed into a huge variety of dairy products such as butter, yoghurt or cheese. The worldwide meat consumption has significantly increased over the last years. According to the Food and Agricultural Organization of the United Nations, patterns of food consumption are shifting towards higher-quality and more expensive foods such as meat and dairy products (FAO, 2002). However, the production of meat and milk requires huge amounts of forage. To assure the availability of such forage, continuously rising amounts of arable land are being used for forage production instead of producing food for humans. Furthermore, the total amount of arable land is limited and has decreased over the last decades due to the increasing worldwide population.

Therefore, it was an object of the present invention to provide a method for increasing the milk and/or meat quantity of silage-fed milk and/or meat producing animals.

One object according to the invention was to provide a method for increasing the milk quantity of silage-fed milk producing animals.

Another object according to the invention was to provide a method for increasing the meat quantity of silage-fed meat producing animals.

Surprisingly we have found that this object can been achieved by applying at least one strobilurin compound to the site, the propagules and/or the plants used for eventually producing silage, which is subsequently being fed to the milk and/or meat producing animals. In particular, strobilurins of formula I are useful for the purpose of the present invention.

For a long time strobilurins have been known as fungicides. In some cases, they have also been described as insecticides (EP-A 178826; EP-A 253213; WO 93/15046; WO 95/18789; WO 95/21153; WO 95/21154; WO 95/24396; WO 96/01256; WO 97/15552; WO 97/27189). Within the last years, they are also known for increasing the health of plants (WO 01/82701; WO 03/075663; WO 07/104,660).

The compounds used according to the present invention, particularly the compounds of formula I, result in an increase in milk and/or meat quantity of animals fed with silage derived from plants treated with at least one strobilurin compound prior to producing said silage.

According to the invention, the increase of the milk quantity, compared to the milk quantity obtained after the milk producing animals were fed with silage that was not derived from plants treated with at least one strobilurin compound according to the invention, is at least 3%, preferably 5 to 10%, more preferably 10 to 20% or even 20 to 30%.

According to the invention, the increase of the meat quantity, compared to the milk quantity obtained after the milk producing animals were fed with silage that was not derived from plants treated with at least one strobilurin compound according to the invention, is at least 3%, preferably 5 to 10% and under certain conditions 10 to 20% or even 20 to 30%.

Specific examples for strobilurins suitable for the present invention are compounds of formula I

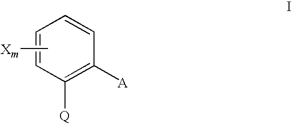

in which the variables are as defined below:
X is halogen, C₁-C₄-alkyl or trifluoromethyl;
m is 0 or 1;
Q is C(═CH—CH₃)—COOCH₃, C(═CH—OCH₃)—COOCH₃, C(═N—OCH₃)—CONHCH₃, C(═N—OCH₃)—COOCH₃, N(—OCH₃)—COOCH₃, or the group Q1

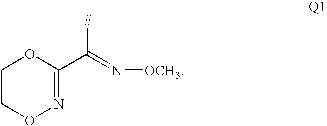

where # denotes the bond to the phenyl ring;
A is —O—B, —CH₂O—B, —OCH₂—B, —CH₂S—B, —CH═CH—B, —C═C—B, —CH₂O—N═C(R¹)—B, —CH₂S—N═C(R¹)—B, —CH₂O—N═C(R¹)—CH═CH—B, or —CH₂O—N═C(R¹)—C(R²)═N—OR³, where
B is phenyl, naphthyl, 5- or 6-membered heteroaryl or 5- or 6-membered heterocyclyl which contains one, two or three nitrogen atoms and/or one oxygen or sulfur atom or one or two oxygen and/or sulfur atoms, where the ring systems are unsubstituted or substituted by one, two or three groups R^{a}:
   R^{a} independently of one another are cyano, nitro, amino, aminocarbonyl, aminothiocarbonyl, halogen, C₁-C₆-alkyl, C₁-C₆-haloalkyl, C₁-C₆-alkylcarbonyl, C₁-C₆-alkylsulfonyl, C₁-C₆-alkylsulfinyl, C₃-C₆-cycloalkyl, C₁-C₆-alkoxy, C₁-C₆-haloalkoxy, C₁-C₆-alkyloxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylaminothiocarbonyl, di-C₁-C₆-alkylaminothiocarbonyl, C₂-C₆-alkenyl, C₂-C₆-alkenyloxy, phenyl, phenoxy, benzyl, benzyloxy, 5- or 6-membered heterocyclyl, 5- or 6-membered heteroaryl, 5- or 6-membered heteroaryloxy, C(═NOR′)—R″ or OC(R′)₂—C(R″)═NOR″, where the cyclic groups for their part may be unsubstituted or substituted by one, two, three, four or five groups R^{b}:
   R^{b} independently of one another are cyano, nitro, halogen, amino, aminocarbonyl, aminothiocarbonyl, C₁-C₆-alkyl, C₁-C₆-haloalkyl, C₁-C₆-alkylsulfonyl, C₁-C₆-alkylsulfinyl, C₃-C₆-cycloalkyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylaminothiocarbonyl, di-C₁-C₆-alkylaminothiocarbonyl, C₂-C₆-alkenyl, C₂-C₆-alkenyloxy, C₃-C₆-cycloalkyl, C₃-C₆-cycloalkenyl, phenyl, phenoxy, phenylthio, benzyl, benzyloxy, 5- or 6-membered heterocyclyl, 5- or 6-membered heteroaryl, 5- or 6-membered heteroaryloxy or C(═NOR′)—R″;
      R′, R″ independently of one another are hydrogen or C₁-C₆-alkyl;
   R¹ is hydrogen, cyano, C₁-C₄-alkyl, C₁-C₄-haloalkyl, C₃-C₆-cycloalkyl, C₁-C₄-alkoxy, or C₁-C₄-alkylthio;
   R² is phenyl, phenylcarbonyl, phenylsulfonyl, 5- or 6-membered heteroaryl, 5- or 6-membered heteroarylcarbonyl or 5- or 6-membered heteroarylsulfonyl, where the ring systems may be unsubstituted or substituted by one, two, three, four or five groups R^{a},
      C₁-C₁₀-alkyl, C₃-C₆-cycloalkyl, C₂-C₁₀-alkenyl, C₂-C₁₀-alkynyl, C₁-C₁₀-alkylcarbonyl, C₂-C₁₀-alkenylcarbonyl, C₃-C₁₀-alkynylcarbonyl, C₁-C₁₀-alkylsulfonyl or C(═NOR′)—R″, where the carbon chains may be unsubstituted or substituted by one, two, three, four or five groups R^{c}:
      R^{c} independently of one another are cyano, nitro, amino, aminocarbonyl, aminothiocarbonyl, halogen, C₁-C₆-alkyl, C₁-C₆-haloalkyl, C₁-C₆-alkylsulfonyl, C₁-C₆-alkylsulfinyl, C₁-C₆-alkoxy, C₁-C₆-haloalkoxy, C₁-C₆-alkoxycarbonyl, C₁-C₆-alkylthio, C₁₀₆-alkylamino, di-C₁-C₆-alkylamino, C₁-C₆-alkylaminocarbonyl, di-C₁-C₆-alkylaminocarbonyl, C₁-C₆-alkylaminothiocarbonyl, di-C₁-C₆-alkylaminothiocarbonyl, C₂-C₆-alkenyl, C₂-C₆-alkenyloxy, C₃-C₆-cycloalkyl, C₃-C₆-cycloalkyloxy, 5- or 6-membered heterocyclyl, 5- or 6-membered heterocyclyloxy, benzyl, benzyloxy, phenyl, phenoxy, phenylthio, 5- or 6-membered heteroaryl, 5- or 6-membered heteroaryloxy or heteroarylthio, where the cyclic groups may be partially or fully halogenated or may be substituted by one, two or three groups R^{a}; and
R³ is hydrogen, C₁-C₆-alkyl, C₂-C₆-alkenyl, C₂-C₆-alkynyl, where the carbon chains may be partially or fully halogenated or may be substituted by one, two, three, four or five groups R^{c}; and
strobilurin compounds selected from the group consisting of methyl (2-chloro-5-[1-(3-methylbenzyloxyimino)ethyl]benzyl)carbamate, methyl (2-chloro-5-[1-(6-methylpyridin-2-ylmethoxyimino)ethyl]benzyl)carbamate, 2-(2-(6-(3-chloro-2-methyl-phenoxy)-5-fluoro-pyrimidin-4-yloxy)-phenyl)-2-methoxy-imino-N-methyl-acetamide and 3-methoxy-2-(2-(N-(4-methoxy-phenyl)cyclo-propane-carboximidoyl-sulfanyl-methyl)-phenyl)-acrylic acid methyl ester;
and their agricultural useful salts.

According to one embodiment of the present invention, applying a strobilurin compound to the site, the plants and plant parts being used for producing silage increases the milk quantity produced by milk producing animals following the consumption of said silage.

According to another embodiment of the present invention, applying a strobilurin compound to the site, the plants and plant parts being used for producing silage increases the meat quantity produced by meat producing animals following the consumption of said silage.

According to one embodiment of the present invention at least one strobilurin compound is applied as seed treatment.

According to one embodiment of the present invention, the silage according to step b) displays an enhanced digestibility.

According to another embodiment of the present invention, the silage according to step b) displays an increased energy content.

According to one embodiment of the present invention the silage-fed animals according to step c) comprise cattle, sheep, swine, horses and/or goats.

The term “plants” is to be understood as plants of economic importance and/or men-grown plants. They are preferably selected from agricultural crops, silvicultural and horticultural (including ornamental) plants. The term plant as used herein includes all parts of a plant such as germinating seeds, emerging seedlings, herbaceous vegetation as well as established woody plants including all belowground portions (such as the roots) and aboveground portions. A non-exhaustive list of plants includes the following genera without restriction: Abutilon, Alfalfa, Amaranthus, Artemisia, Asclepias, Avena, Axonopus, Borreria, Brachiaria, Brassica, Bromus, Chenopodium, Cirsium, Commelina, Convolvulus, Cynodon, Cyperus, Digitaria, Echinochloa, Eleusine, Elymus, Equisetum, Erodium, Helianthus, Imperata, Ipomoea, Kochia, Lolium, Malva, Oryza, Ottochloa, Panicum, Paspalum, Phalaris, Phragmites, Polygonum, Portulaca, Pteridium, Pueraria, Rubus, Salsola, Secale, Setaria, Sida, Sinapis, Sorghum, Spergula, Trifolium, Triticum, Typha, Ulex, Vicia, Xanthium and Zea.

In one embodiment according to the invention, the plant is selected from agricultural crops, silvicultural and horticultural plants, each in its natural or genetically modified form (GMOs). Such GMOs may have improved properties such as improved stress tolerance and resistance of the plants against biotic and abiotic stress factors such as fungi, bacteria, viruses, insects, heat stress, cold stress, drought stress, UV stress and/or salt stress.

“Propagules” are all types of plant propagation material. The term embraces seeds, grains, fruit, tubers, rhizomes, spores, cuttings, offshoots, meristem tissues, single and multiple plant cells and any other plant tissue from which a complete plant can be obtained. One particular propagule is seed.

“Milk” is a liquid produced by female mammals. The exact composition of raw milk can vary significantly by species. Generally, it contains high amounts of saturated fat, protein and calcium. Milk can be processed in a great variety of ways, the products of which are called dairy products.

“Meat” is animal tissue used for example as food. The term meat typically refers to skeletal muscle and associated fat, but it may also refer to non-muscle organs, including lungs, livers, skin, brains, bone marrow and kidneys.

“Milk producing animals” are to be understood as all female animals from the class of mammals e.g. cattle, sheep, swine, goats, horses, camels, buffalos and/or yaks.

“Meat producing animals” are to be understood as all animals used for producing meat such as cattle, sheep, swine, goats, horses, camels, poultry, buffalos and/or yaks.

“Silage” is a certain type of storage forage. Generally, silage is being made from plants in a process called ensilage. During this process, plants or plant parts undergo anaerobic fermentation caused by indigenous microorganisms (e.g. one or more strains of lactic acid bacteria like Lactobacillus spec.) converting sugars to acids and exhausting any oxygen present in the crop material making the forage preservable. Depending on the plants used, other names instead of silage are employed e.g. oatlage for oats or haylage for alfalfa. Silage is widely applied for feeding milk and meat producing animals such as dairy and beef cattle.

The term “producing silage” describes the process of how to obtain silage suitable for feeding the milk and meat producing animals. Silage is produced from plants by chopping the harvested plant biomass with a forage harvester. Suitable plants may be forage crops such as corn (maize), cereals like wheat, rye or barley, pasture, clover, alfalfa and other leguminous crops, sunflower and any other plants suitable for ensiling and mixtures of any said plants.

The plants are harvested at a dry matter content of about 30 to 40% to enable an optimal fermentation process during the ensiling and to minimize losses during fermentation. For pasture, clover, alfalfa, mixtures thereof and other crops it can be necessary to let the plant material dry down in the field to reach a dry matter of 30 to 40% after mowing and before chopping with a forage harvester. Such material is known as haylage. For corn or cereals the grain is harvested together with the rest of the plant. To make the nutrients in the grain available for the uptake in the intestinal tract of a fed animal, it may be necessary to crush the grain during the chopping process in the forage harvester. The harvested and chaffed plant material is transferred into a silo. The silo can be a bunker silo, a silage heap, or a concrete stave silo or a tower silo. In the silo, the chaffed plant material is compacted to eliminate the air out of the plant material to enable an anaerobic fermentation. It may be necessary to seal the silo with a plastic film (silage film) depending of the type of silo used. Another method to compact and seal the plant material for fermentation during ensiling is to bale the plant material and wrap the bales in a silage film for sealing. Additives may be added to the plant material to improve the fermentation. Additives may be microbial additives like Lactobacillus spp. and other inoculants, or acids such as propionic acid, acetetic acid or formic acid, or sugars or sugar containing material like molasses. However, other methods for producing silage may be also used. One advantage of the process of producing silage (ensilage) is the fact that the process has no influence on the composition, the amount or availability of the nutritive substances included by the plant material used for producing said silage. On the contrary, the purpose of the process itself is not only to keep the quality of the plant material as it was prior to using such material for producing silage but in addition, to make the forage preservable and to conserve the positive properties of the plant material for an extended period of time so that it can be used as forage long after the harvest has been carried out.

“Digestibility” is the property of a plant, part of a plant, mixture of plants, compositions of forage or animal feed processed from plants (such as silage) contributing to the nutritional value of a plant, part of a plant, mixture of plants, compositions of forage or animal feed processed from plants (such as silage) describing the relative amount of nutrients (nutritive substances), which are not excreted via faeces but absorbed in the intestinal tract of an animal which is fed with the plant, part of a plant, mixture of plants, compositions of forage or animal feed processed from plants (such as silage) having an impact on the performance of said animal. Parameter that describe the digestibility of forages are for example Neutral Detergent Fiber Digestibility (NDFD), Acid Detergent Fiber (ADF) and Total Digestible Nutrients as percent of Dry Matter (TDN % DM).

The term “Neutral Detergent Fiber Digestibility (NDFD)” is to be understood as a measure of fiber after digestion in a neutral detergent as an aid in determining quality and digestibility of forages. High NDFD is desirable. Evaluation of forages for NDFD digestibility is being conducted to aid prediction of total forage digestibility.

“Acid Detergent Fiber (ADF)” represents the less digestible portion of the forage, containing cellulose, lignin and heat damaged protein. ADF is closely related to the digestibility of forages. Lower ADF implies the forage is more digestible. A low concentration of ADF is desirable.

The term “Total Digestible Nutrients as percent of Dry Matter (TDN % DM)” describes the total amount of digestible nutrients by measuring the available energy of the forage and energy requirements of animals. This is a measure of forage digestibility. A high TDN % DM is desirable.

The term “energy content” comprises the content of all ingredients or components of a plant, part of a plant, mixture of plants, compositions of forage or animal feed processed from plants (such as silage) that contribute to supplying the energy demand of an animal fed with the plant, part of a plant, mixture of plants, compositions of forage or animal feed processed from plants (such as silage) for maintenance of vital functions such as basic physiological processes of said animal and performance of said animal such as milk production in case of a lactating cow, sheep, goat, or swine and/or weight gain. One parameter that describes the energy content of forages is Neutral Detergent Fiber (NDF).

The term “Neutral Detergent Fiber (NDF)” is to be understood as a measure of fiber content of the forage. It is less digestible than non-fiber constituents of the forage. Forages with low NDF levels have higher energy. Consequently, a low NDF content is desirable.

“Starch” is to be understood as the starch content of the forage, along with digestible component of the fiber. Starch accounts for the majority of the energy, for example in corn silage.

The term “Dry Matter (DM)” is to be understood as the total weight of forage minus the weight of water in the forage, expressed as a percentage.

The term “site” is defined as a certain place at a certain time used for agricultural, horticultural or silvicultural production, being affected by the entirety of all biotic (such as plants, animals, fungi) and abiotic (such as climate, soil-type, water availability) parameters influencing the growth, the development and the yield of the present plants.

The term “crop” is to be understood as any plant product which is further utilized after harvesting, for example fruits in the proper sense, vegetables, nuts, grains, seeds, wood (for example in the case of silviculture plants), flowers (for example in the case of gardening and ornamental plants) etc.; that means anything of economic value that is produced by the plant.

The term “at least one strobilurin compound” is to be understood as 1, 2, 3 or more strobilurins.

According to the invention, the strobilurin compounds, more specifically the strobilurins of formula I, are applied to plants used for producing silage.

According to one embodiment of the present invention, the silage used for feeding the milk and meat producing animals, is derived from Zea mays (maize), grass, clovers, sorghum, oat, rye, vetches, alfalfa, grass mixes and/or weeds treated with at least one strobilurin compound prior to producing silage according to the invention.

According to one embodiment of the present invention at least one strobilurin compound is applied to plants and/or its propagules comprising Zea mays (maize), grass, clovers, sorghum, oat, rye, vetches, alfalfa, grass mixes and/or weeds.

According to a preferred embodiment of the present invention, the silage used for feeding the milk and meat producing animals is derived from Zea mays (maize) plants treated with at least one strobilurin compound prior to producing silage according to the invention.

According to one embodiment of the present invention, the silage used for feeding the milk and meat producing animals is derived from Zea mays (maize) plants treated with pyraclostrobin (compound I-5) prior to producing silage according to the invention.

According to another embodiment of the present invention, the silage used for feeding the animals is derived from Zea mays (maize) plants treated with kresoxim-methyl (compound II-1) prior to producing silage.

In one embodiment of the invention, the silage according to the invention used for increasing the milk quantity, is fed to cattle, preferably dairy cattle.

In one embodiment of the invention, the silage according to the invention used for increasing the meat quantity, is fed to cattle, preferably beef cattle.

In another embodiment of the invention, the silage according to the invention for increasing the milk quantity is fed to horses.

In another embodiment of the invention, the silage according to the invention for increasing the meat quantity is fed to horses.

In one embodiment of the invention, compounds of formula I, as defined in the outset are used.

In addition, following compounds as listed in the tables below may be preferably used according to the invention.

TABLE I
II

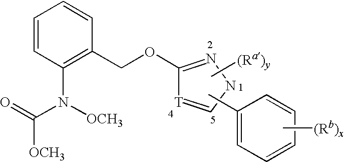

| | | | Position of the group | | |
|---|---|---|---|---|---|
| No. | T | (R^{a′})_{y} | phenyl-(R^{b})ₓ | (R^{b})ₓ | Reference |
| I-1 | N | — | 1 | 2,4-Cl₂ | WO 96/01256 |
| I-2 | N | — | 1 | 4-Cl | WO 96/01256 |
| I-3 | CH | — | 1 | 2-Cl | WO 96/01256 |
| I-4 | CH | — | 1 | 3-Cl | WO 96/01256 |
| I-5 | CH | — | 1 | 4-Cl | WO 96/01256 |
| I-6 | CH | — | 1 | 4-CH₃ | WO 96/01256 |
| I-7 | CH | — | 1 | H | WO 96/01256 |
| I-8 | CH | — | 1 | 3-CH₃ | WO 96/01256 |
| I-9 | CH | 5-CH₃ | 1 | 3-CF₃ | WO 96/01256 |
| I-10 | CH | 1-CH₃ | 5 | 3-CF₃ | WO 99/33812 |
| I-11 | CH | 1-CH₃ | 5 | 4-Cl | WO 99/33812 |
| I-12 | CH | 1-CH₃ | 5 | — | WO 99/33812 |

TABLE II
III

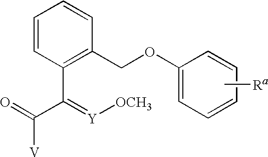

| No. | V | Y | R^{a} | Reference |
|---|---|---|---|---|
| II-1 | OCH₃ | N | 2-CH₃ | EP-A 253 213 |
| II-2 | OCH₃ | N | 2,5-(CH₃)₂ | EP-A 253 213 |
| II-3 | NHCH₃ | N | 2,5-(CH₃)₂ | EP-A 477 631 |
| II-4 | NHCH₃ | N | 2-Cl | EP-A 398 692 |
| II-5 | NHCH₃ | N | 2-CH₃ | EP-A 398 692 |
| II-6 | NHCH₃ | N | 2-CH₃, 4-OCF₃ | EP-A 628 540 |
| II-7 | NHCH₃ | N | 2-C1, 4-OCF₃ | EP-A 628 540 |
| II-8 | NHCH₃ | N | 2-CH₃, 4-OCH(CH₃)—C(CH₃)═NOCH₃ | EP-A 1118 609 |
| II-9 | NHCH₃ | N | 2-Cl, 4-OCH(CH₃)—C(CH₃)═NOCH₃ | EP-A 1118 609 |
| II-10 | NHCH₃ | N | 2-CH₃, 4-OCH(CH₃)—C(CH₂CH₃)═NOCH₃ | EP-A 1118 609 |
| II-11 | OCH₃ | CH | 2,5-(CH₃)₂ | EP-A 226 917 |

TABLE III
IV

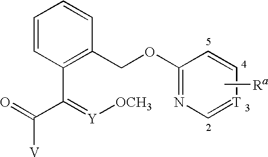

| No. | V | Y | T | R^{a} | Reference |
|---|---|---|---|---|---|
| III-1 | OCH₃ | CH | N | 2-OCH₃, 4-CF₃ | WO 96/16047 |
| III-2 | OCH₃ | CH | N | 2-OCH(CH₃)₂, 4-CF₃ | WO 96/16047 |
| III-3 | OCH₃ | CH | CH | 2-CF₃ | EP-A 278595 |
| III-4 | OCH₃ | CH | CH | 4-CF₃ | EP-A 278595 |
| III-5 | NHCH₃ | N | CH | 2-Cl | EP-A 398692 |
| III-6 | NHCH₃ | N | CH | 2-CF₃ | EP-A 398692 |
| III-7 | NHCH₃ | N | CH | 2-CF₃, 4-Cl | EP-A 398692 |
| III-8 | NHCH₃ | N | CH | 2-Cl, 4-CF₃ | EP-A 398692 |

TABLE IV
V

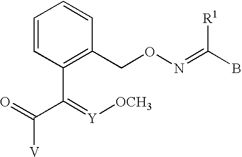

| No. | V | Y | R¹ | B | Reference |
|---|---|---|---|---|---|
| IV-1 | OCH₃ | CH | CH₃ | (3-CF₃)C₆H₄ | EP-A 370629 |
| IV-2 | OCH₃ | CH | CH₃ | (3,5-Cl₂)C₆H₃ | EP-A 370629 |
| IV-3 | NHCH₃ | N | CH₃ | (3-CF₃)C₆H₄ | WO 92/13830 |
| IV-4 | NHCH₃ | N | CH₃ | (3-OCF₃)C₆H₄ | WO 92/13830 |
| IV-5 | OCH₃ | N | CH₃ | (3-OCF₃)C₆H₄ | EP-A 460575 |
| IV-6 | OCH₃ | N | CH₃ | (3-CF₃)C₆H₄ | EP-A 460575 |
| IV-7 | OCH₃ | N | CH₃ | (3,4-Cl₂)C₆H₃ | EP-A 460575 |
| IV-8 | OCH₃ | N | CH₃ | (3,5-Cl₂)C₆H₃ | EP-A 463488 |
| IV-9 | OCH₃ | CH | CH₃ | CH═CH-(4-Cl)C₆H₄ | EP-A 936213 |

TABLE V
VI

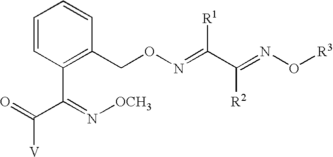

| No. | V | R¹ | R² | R³ | Reference |
|---|---|---|---|---|---|
| V-1 | OCH₃ | CH₃ | CH₃ | CH₃ | WO 95/18789 |
| V-2 | OCH₃ | CH₃ | CH(CH₃)₂ | CH₃ | WO 95/18789 |
| V-3 | OCH₃ | CH₃ | CH₂CH₃ | CH₃ | WO 95/18789 |
| V-4 | NHCH₃ | CH₃ | CH₃ | CH₃ | WO 95/18789 |
| V-5 | NHCH₃ | CH₃ | 4-F—C₆H₄ | CH₃ | WO 95/18789 |
| V-6 | NHCH₃ | CH₃ | 4-Cl—C₆H₄ | CH₃ | WO 95/18789 |
| V-7 | NHCH₃ | CH₃ | 2,4-C₆H₃ | CH₃ | WO 95/18789 |
| V-8 | NHCH₃ | Cl | 4-F—C₆H₄ | CH₃ | WO 98/38857 |
| V-9 | NHCH₃ | Cl | 4-Cl—C₆H₄ | CH₂CH₃ | WO 98/38857 |
| V-10 | NHCH₃ | CH₃ | CH₂C(═CH₂)CH₃ | CH₃ | WO 97/05103 |
| V-11 | NHCH₃ | CH₃ | CH═C(CH₃)₂ | CH₃ | WO 97/05103 |
| V-12 | NHCH₃ | CH₃ | CH═C(CH₃)₂ | CH₂CH₃ | WO 97/05103 |
| V-13 | NHCH₃ | CH₃ | CH═C(CH₃)CH₂CH₃ | CH₃ | WO 97/05103 |
| V-14 | NHCH₃ | CH₃ | O—CH(CH₃)₂ | CH₃ | WO 97/06133 |
| V-15 | NHCH₃ | CH₃ | O—CH₂CH(CH₃)₂ | CH₃ | WO 97/06133 |
| V-16 | NHCH₃ | CH₃ | C(CH₃)═NOCH₃ | CH₃ | WO 97/15552 |

TABLE VI
VII

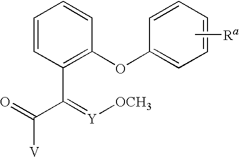

| No. | V | Y | R^{a} | Reference |
|---|---|---|---|---|
| VI-1 | NHCH₃ | N | H | EP-A 398692 |
| VI-2 | NHCH₃ | N | 3-CH₃ | EP-A 398692 |
| VI-3 | NHCH₃ | N | 2-NO₂ | EP-A 398692 |
| VI-4 | NHCH₃ | N | 4-NO₂ | EP-A 398692 |
| VI-5 | NHCH₃ | N | 4-Cl | EP-A 398692 |
| VI-6 | NHCH₃ | N | 4-Br | EP-A 398692 |

TABLE VII
VIII

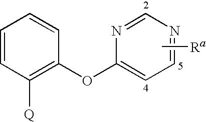

| No. | Q | R^{a} | Reference |
|---|---|---|---|
| VII-1 | C(═CH—OCH₃)COOCH₃ | 5-O-(2-CN—C₆H₄) | EP-A 382375 |
| VII-2 | C(═CH—OCH₃)COOCH₃ | 5-O-(2-Cl—C₆H₄) | EP-A 382375 |
| VII-3 | C(═CH—OCH₃)COOCH₃ | 5-O-(2-CH₃—C₆H₄) | EP-A 382375 |
| VII-4 | C(═N—OCH₃)CONHCH₃ | 5-O-(2-Cl—C₆H₄) | GB-A 2253624 |
| VII-5 | C(═N—OCH₃)CONHCH₃ | 5-O-(2,4-Cl₂—C₆H₃) | GB-A 2253624 |
| VII-6 | C(═N—OCH₃)CONHCH₃₃ | 5-O-(2-CH₃—C₆H₄) | GB-A 2253624 |
| VII-7 | C(═N—OCH₃)CONHCH₃ | 5-O-(2-CH₃,3-Cl—C₆H₃) | GB-A 2253624 |
| VII-8 | C(═N—OCH₃)CONHCH₃ | 4-F, 5-O-(2-CH₃—C₆H₄) | WO 98/21189 |
| VII-9 | C(═N—OCH₃)CONHCH₃ | 4-F, 5-O-(2-Cl—C₆H₄) | WO 98/21189 |
| VII-10 | C(═N—OCH₃)CONHCH₃ | 4-F, 5-O-(2-CH₃,3-Cl—C₆H₃) | WO 98/21189 |
| VII-11 | Q1 | 4-F, 5-O-(2-Cl—C₆H₄) | WO 97/27189 |
| VII-12 | Q1 | 4-F, 5-O-(2-CH₃,3-Cl—C₆H₃) | WO 97/27189 |
| VII-13 | Q1 | 4-F, 5-O-(2,4-Cl₂—C₆H₃) | WO 97/27189 |

Preferred for the use according to the invention are the commercially available strobilurin compounds such as compound I-5 (pyraclostrobin), II-1 (kresoxim-methyl), II-3 (dimoxystrobin), II-11 (E)-2-[2-(2,5-Dimethyl-phenoxymethyl)-phenyl]-3-methoxy-acrylic acid methyl ester (ZJ 0712), III-3 (picoxystrobin), IV-6 (trifloxystrobin), IV-9 (enestroburin), V-16 (orysastrobin), VI-1 (metominostrobin), VII-1 (azoxystrobin) and VII-11 (fluoxastrobin).

A further compound of formula I that is useful according to the invention is fluacrypyrim (methyl (E)-2-{α-[2-isopropoxy-6-(trifluoromethyl)pyrimidin-4-yloxy]-o-tolyl}-3-methoxyacrylate).

Preference for the use according to the invention is given to the strobilurin compounds I-5 (pyraclostrobin), II-1 (kresoxim-methyl) and V-16 (orysastrobin).

Particular preference for the use according to the invention is given to the strobilurin compounds I-5 (pyraclostrobin) and II-1 (kresoxim-methyl).

Preference for the use according to the invention is especially given to the strobilurin compound I-5 (pyraclostrobin).

Special preference for the use according to the invention is also given to the strobilurin compound II-1 (kresoxim-methyl).

In the context of the present invention, the term “compounds of formula I” refers both to the neutral compounds of formula I and to the other strobilurin compounds mentioned at the outset. The compounds of formula I mentioned above can also be employed in the form of their agriculturally useful salts. These are usually salts or adducts with inorganic or organic acids or with metal ions, such as alkali metal or alkaline earth metal salts, for example sodium, potassium or calcium salts.

Examples of inorganic acids are hydrohalic acids, such as hydrogen fluoride, hydrogen chloride, hydrogen bromide and hydrogen iodide, sulfuric acid, phosphoric acid and nitric acid.

Suitable organic acids are, for example, formic acid, carbonic acid and alkanoic acids, such as acetic acid, trifluoroacetic acid, trichloroacetic acid and propionic acid, and also glycolic acid, lactic acid, succinic acid, citric acid, benzoic acid, cinnamic acid, oxalic acid, p-toluenesulfonic acid, salicylic acid, p-aminosalicylic acid, 2-phenoxybenzoic acid or 2-acetoxybenzoic acid.

Suitable metal ions are in particular the ions of the elements of the first to eighth transition group, especially chromium, manganese, iron, cobalt, nickel, copper, zinc, and additionally those of the second main group, especially calcium and magnesium, and of the third and fourth main group, in particular aluminum, tin and lead. If appropriate, the metals can be present in the different valencies that they can assume.

In one embodiment of the present invention, the strobilurin compound is used in step a) together with a further active compound.

The strobilurin compounds used according to the invention, specifically the compounds of formula I, can be employed for application in all of the above-mentioned plants, but also in plant species, which differ from them. Depending on the plant part to which they are to be applied, they can be applied with apparatuses which are known per se and conventionally used in agricultural practice, application in the form of an aqueous spray solution or spray mixture being preferred.

The inventive method is suitable for foliar application in living crops of plants, for soil applications prior to sowing or planting, including overall soil treatment and in furrow applications, as well as, in particular, for dressing applications on plant propagation material. The latter term embraces seeds of all kinds (such as fruit, tubers, grains), cuttings, cut shoots and the like. One field of application is the treatment of all kinds of seeds. One suitable method is the application by airplane.

Application is effected by spraying to run-off point or by seed dressing. Either all of the aerial plant part or else only individual plant parts, such as flowers, leaves or fruits, are treated. The choice of the individual plant parts to be treated depends on the species of the plant and its developmental stage. Later stages may be treated preferably by leaf applications. In one embodiment the application is onto seed. It is preferred to treat the embryos, seedlings, buds and flowers in various developmental stages, and the young fruits.

The compounds used according to the present invention, particularly the compounds of formula I, are preferably employed in an application rate of from 25 to 1000 g/ha, particular preferably from 50 to 500 g/ha and in particular from 50 to 250 g/ha.

A further embodiment of the present invention is directed to the seeds being treated with the compounds of formula I according to the present invention.

In the treatment of seeds, the application rates of the compounds of formula I according to the invention are, depending on the nature of the seeds, generally from 1 to 1000 g a.i./100 kg, from 5 to 100 g a.i./100 kg, from 5 to 20 g a.i./100 kg, from 5 to 10 g a.i./100 kg, from 30 g to 3000 g a.i./100 kg, from 1 g to 100 g a.i./100 kg of seeds. For certain crop seeds the rates may be higher.

The compositions according to the invention may also be present together with other compounds, for example with herbicides, insecticides, growth regulators, fungicides or else with fertilizers.

The following lists of fungicides, insecticides, growth retardants and primers which can be used together with the strobilurin compound is meant to illustrate, but not to limit, possible combinations:

### Carboxamides

carboxanilides: benalaxyl, benalaxyl-M, benodanil, bixafen, boscalid, carboxin, mepronil, fenfuram, fenhexamid, flutolanil, furametpyr, metalaxyl, ofurace, oxadixyl, oxycarboxin, penthiopyrad, thifluzamide, tiadinil, 2-amino-4-methylthiazole-5-carboxylic acid anilide, 2-chloro-N-(1,1,3-trimethyl-indan-4-yl)-nicotinamide, N-(4′-bromobiphenyl-2-yl)-4-difluoromethyl-2-methylthiazole-5-carboxamide, N-(4′-trifluoromethylbiphenyl-2-yl)-4-difluoromethyl-2-methylthiazole-5-carboxamide, N-(4′-chloro-3′-fluorobiphenyl-2-yl)-4-difluoromethyl-2-methylthiazole-5-carboxamide, N-(3′,4′-dichloro-4-fluorobiphenyl-2-yl)-3-difluoromethyl-1-methylpyrazole-4-carboxamide, N′-(3′,4′-dichloro-5-fluorobiphenyl-2-yl)-3-difluoromethyl-1-methylpyrazole-4-carboxamide, N-(2-cyanophenyl)-3,4-dichloroisothiazole-5-carboxamide, N-(2-(1,3-dimethylbutyl)-phenyl)-1,3,3-trimethyl-5-fluoro-1H-pyrazole-4-carboxylic acid amide, N-(4′-chloro-3′,5-difluoro-biphenyl-2-yl)-3-difluoromethyl-1-methyl-1H-pyrazole-4-carboxylic acid amide, N-(4′-chloro-3′,5-difluoro-biphenyl-2-yl)-3-trifluoromethyl-1-methyl-1H-pyrazole-4-carboxylic acid amide, N-(3′,4′-dichloro-5-fluoro-biphenyl-2-yl)-3-trifluoromethyl-1-methyl-1H-pyrazole-4-carboxylic acid amide, N-(3′,5-difluoro-4′-methyl-biphenyl-2-yl)-3-difluoromethyl-1-methyl-1H-pyrazole-4-carboxylic acid amide, N-(3′,5-difluoro-4′-methyl-biphenyl-2-yl)-3-trifluoromethyl-1-methyl-1H-pyrazole-4-carboxylic acid amide, N-(cis-2-bicyclopropyl-2-ylphenyl)-3-difluoromethyl-1-methyl-1H-pyrazole-4-carboxylic acid amide, N-(trans-2-bicyclopropyl-2-yl-phenyl)-3-difluoromethyl-1-methyl-1H-pyrazole-4-carboxylic acid amide;
carboxylic acid morpholides: dimethomorph, flumorph;
benzamides: flumetover, fluopicolide (picobenzamid), fluopyram, zoxamide, N-(3-Ethyl-3,5-5-trimethyl-cyclohexyl)-3-formylamino-2-hydroxy-benzamide;
other carboxamides: carpropamid, diclocymet, mandipropamid, oxytetracyclin, silthiofam, N-(6-methoxy-pyridin-3-yl)cyclopropanecarboxylic acid amide, N-(2-(4-[3-(4-chlorophenyl)prop-2-ynyloxy]-3-methoxyphenyl)ethyl)-2-methanesulfonylamino-3-methylbutyramide, N-(2-(4-[3-(4-chlorophenyl)prop-2-ynyloxy]-3-methoxyphenyl)-ethyl)-2-ethanesulfonylamino-3-methylbutyramide;

### Azoles

triazoles: azaconazole, bitertanol, bromuconazole, cyproconazole, difenoconazole, diniconazole, diniconazole-M, enilconazole, epoxiconazole, fenbuconazole, flusilazole, fluquinconazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimenol, triadimefon, triticonazole, uniconazole, 1-(4-chloro-phenyl)-2-([1,2,4]triazol-1-yl)-cycloheptanole;
imidazoles: cyazofamid, imazalil, imazalil-sulfphat, pefurazoate, prochloraz, triflumizole;
benzimidazoles: benomyl, carbendazim, fuberidazole, thiabendazole;
others: ethaboxam, etridiazole, hymexazole;

### Nitrogenous Heterocyclyl Compounds

pyridines: fluazinam, pyrifenox, 3-[5-(4-chlorophenyl)-2,3-dimethylisoxazolidin-3-yl]pyridine, 2,3,5,6-tetrachloro-4-methanesulfonyl-pyridine, 3,4,5-trichloropyridine-2,6-dicarbonitrile, N-(1-(5-Bromo-3-chloro-pyridin-2-yl)-ethyl)-2,4-dichloro-nicotinamide, N-((5-bromo-3-chloro-pyridin-2-yl)-methyl)-2,4-dichloro-nicotinamide;
pyrimidines: bupirimate, cyprodinil, diflumetorim, ferimzone, fenarimol, mepanipyrim, nitrapyrin, nuarimol, pyrimethanil;
piperazines: triforine;
pyrroles: fludioxonil, fenpiclonil;
morpholines: aldimorph, dodemorph, dodemorph-acetate, fenpropimorph, tridemorph;
dicarboximides: iprodione, fluoroimid, procymidone, vinclozolin;
others: acibenzolar-S-methyl, anilazine, blasticidin-S, captan, chinomethionat, captafol, dazomet, debacarb, diclomezine, difenzoquat, difenzoquat-methylsulphat, fenoxanil, folpet, oxolinic acid, piperalin, fenpropidin, famoxadone, fenamidone, octhilinone, probenazole, proquinazid, pyroquilon, quinoxyfen, tricyclazole, 5-chloro-7-(4-methylpiperidin-1-yl)-6-(2,4,6-trifluorophenyl)-[1,2,4]triazolo[1,5-a]pyrimidine, 2-butoxy-6-iodo-3-propylchromen-4-one, N,N-dimethyl-3-(3-bromo-6-fluoro-2-methylindole-1-sulfonyl)-[1,2,4]triazole-1-sulfonamide;

### Carbamates and Dithiocarbamates

dithiocarbamates: ferbam, mancozeb, maneb, metiram, metam, methasulphocarb, propineb, thiram, zineb, ziram;
carbamates: diethofencarb, benthiavalicarb, flubenthiavalicarb, iprovalicarb, propamocarb, propamocarb hydrochlorid, methyl 3-(4-chlorophenyl)-3-(2-isopropoxycarbonylamino-3-methylbutyrylamino)propionate, 4-fluorophenyl N-(1-(1-(4-cyanophenyl)ethanesulfonyl)but-2-yl)carbamate;

### Other Fungicides

guanidines: dodine, dodine free base, guazatine, guazatine-acetate, iminoctadine, iminoctadine-triacetate, iminoctadine-tris(albesilate);
antibiotics: kasugamycin, kasugamycin-hydrochlorid-hydrat, polyoxins, streptomycin, validamycin A;
organometal compounds: fentin salts (e.g. fentin acetate, fentin chloride, fentin hydroxide);
sulfur-containing heterocyclyl compounds: isoprothiolane, dithianon;
organophosphorus compounds: edifenphos, fosetyl, fosetyl-aluminum, iprobenfos, pyrazophos, tolclofos-methyl, phosphorous acid and its salts;
organochlorine compounds: thiophanate methyl, chlorothalonil, dichlofluanid, dichlorophene, flusulfamide, phthalide, hexachlorobenzene, pencycuron, pentachlorophenol and salts thereof, quintozene, tolylfluanid, N-(4-chloro-2-nitrophenyl)-N-ethyl-4-methyl-benzenesulfonamide;
nitrophenyl derivatives: binapacryl, dicloran, dinocap, dinobuton, nitrothal-isopropyl, tecnazen;
inorganic active compounds: Bordeaux mixture, copper salts (e.g. copper acetate, copper hydroxide, copper oxychloride, basic copper sulfate), sulfur;
others: biphenyl, bronopol, cyflufenamid, cymoxanil, diphenylamine, metrafenone, mildiomycine, oxine-copper, prohexadione-calcium, spiroxamine, tolylfluanid, N-(cyclopropylmethoxyimino-(6-difluoromethoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N-methyl formamidine, N′-(4-(4-fluoro-3-trifluoromethylphenoxy)-2,5-dimethyl-phenyl)-N-ethyl-N-methyl formamidine, N′-(2-methyl-5-trifluormethyl-4-(3-trimethylsilanyl-propoxy)-phenyl)-N-ethyl-N-methyl formamidine, N′-(5-difluormethyl-2-methyl-4-(3-trimethylsilanyl-propoxy)-phenyl)-N-ethyl-N-methyl formamidine;

### Plant Growth Regulators (PGRs):

auxins (e.g. β-indoleacetic acid (IAA), 4-indol-3-ylbutyric acid (IBA), 2-(1-naphthyl)acetamide (NAA)), cytokinins, gibberellins, ethylene, abscisic acid.

### Growth Retardants:

prohexadione and its salts, trinexapac-ethyl, chlormequat, mepiquat-chloride, diflufenzopyr.

### Primers:

benzothiadiazole (BTH), salicylic acid and its derivates, β-aminobutyric acid (BABA), 1-methylcyclopropene (1-MCP), lipopolysaccharides (LPS), neonicotinoides (e.g. acetamiprid, clothianidin, dinetofuran, imidacloprid, thiacloprid, thiamethoxam).
   GABA-antagonists: e.g. fipronil.

### Ethylene Modulators:

ethylene biosynthesis inhibitors, which inhibit the conversion of S-adenosyl-L-methionine into 1-aminocyclopropane-1-carboxylic acid (ACC), such as derivatives of vinylglycine, hydroxylamines, oxime ether derivatives;
ethylene biosynthesis inhibitors which block the conversion of ACC into ethylene, selected from the group consisting of: Co++ or Ni++ ions in plant-available forms; phenolic radical scavengers such as n-propyl gallate; polyamines, such as putrescine, spermine or spermidine; structural analogs of ACC, such as α-aminoisobutyric acid or L-aminocyclopropene-1-carboxylic acid; salicylic acid or acibenzolar-S-methyl; structural analogs of ascorbic acid which act as inhibitors of ACC oxidase, such as prohexadione-Ca or trinexapac-ethyl; and triazolyl compounds such as paclobutrazol or uniconazole as inhibitors of cytochrome P-450-dependent monooxygenases, whose main action is to block the biosynthesis of gibberellins;
inhibitors of the action of ethylene selected from the group consisting of: structural analogs of ethylene (e.g. cyclopropene derivatives such as 1-methylcyclopropene) or 2,5-norbornadiene and 3-amino-1,2,4-triazole or Ag++ ions.

In a preferred embodiment the strobilurin compounds, specifically the compounds of formula I, are used according to the invention in combination with:

Abscisic acid is (S)(+)-5-(1-hydroxy-2,6,6-trimethyl-4-oxo-2-cyclohexenyl)-3-methyl-cis/trans-2,4-pentadienoic acid.

The active compounds mentioned above are generally known and commercially available.

In one embodiment of the present invention, the compounds of formula I are used for increasing the milk quantity of silage-fed animals.

In another embodiment of the present invention, the compounds of formula I are used for increasing the meat quantity of silage-fed animals.

In one embodiment of the method according to the invention, the application of at least one strobilurin compound according to step a) can be made in the absence of pest pressure.

In one embodiment of the method according to the invention, the application of at least one strobilurin compound according to step a) can be made by airplane.

In plant physiology, “primers” are compounds known for priming activity. The term priming is known as a process, which finally results in enhanced capability of plants to cope with both biotic (for example fungal pathogens) and abiotic (for example drought) stress. Since primers interact in a complex manner with signaling in plants, in general they can be classified as a subgroup of bioregulators (Reviewed in Conrath et al. (2006) Priming: Getting ready for battle. Molecular Plant-Microbe Interactions 19: 1062-1071).

“Ethylene modulators” are to be understood as substances, which block the natural formation of the plant hormone ethylene or else its action. [Reviews for example in M. Lieberman (1979), Biosynthesis and action of ethylene, Annual Review of Plant Physiology 30: 533-591; S. F. Yang and N. E. Hoffman (1984), Ethylene biosynthesis and its regulation in higher plants, Annual Review of Plant Physiology 35: 155-189; E. S. Sisler et. al. (2003), 1-substituted cyclopropenes: Effective blocking agents for ethylene action in plants, Plant Growth Regulation 40: 223-228; WO/2005/044002].

The strobilurin compounds used according to the invention, specifically the compounds of formula I, or their above-mentioned combination can be applied to plants and/or propagules and/or sites where the plants are growing or are to grow as a mixture or separately; in the latter case, the individual components should be applied within as short an interval as possible.

Typically, the strobilurin compounds are employed in the form of an aqueous spray liquor comprising said strobilurin compound in an amount of from 5 to 1000 ppm.

The application rates of at least one strobilurin compound according to the invention is in the range from 25 to 1000 g/ha.

According to a further aspect, the present invention relates to seed, comprising one of the inventive compositions as defined herein in an amount of from 5 to 1000 g active ingredient per 100 kg of seeds.

The compounds used according to the invention, specifically the strobilurin compounds of formula I, or their combination with the abovementioned auxiliaries, are typically employed as formulations as they are conventionally used in the field of crop protection.

The active compound(s) according to the invention can be prepared, for example, in the form of directly sprayable solutions, powders and suspensions or in the form of highly concentrated aqueous, oily or other suspensions, dispersions, emulsions, oil dispersions, pastes, dusts, compositions for spreading or granules, and be applied by spraying, atomizing, dusting, broadcasting, watering, chemigation (i.e. injecting a chemical into irrigation water and applying the chemical through various systems to the crop or field) or colored suspension, solution, emulsion to be applied as such or as water based slurry with seed treatment machinery. The use form depends on the particular purpose; in each case, it should ensure a distribution of the mixture according to the invention, which is as fine and uniform as possible.

The formulations are prepared in a known manner (see e.g. for review U.S. Pat. No. 3,060,084, EP-A 707 445 (for liquid concentrates), Browning, “Agglomeration”, Chemical Engineering, Dec. 4, 1967, 147-48, Perry's Chemical Engineer's Handbook, 4th Ed., McGraw-Hill, New York, 1963, pages 8-57 and et seq. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman, Weed Control as a Science, John Wiley and Sons, Inc., New York, 1961, Hance et al., Weed Control Handbook, 8th Ed., Blackwell Scientific Publications, Oxford, 1989 and Mollet, H., Grubemann, A., Formulation technology, Wiley VCH Verlag GmbH, Weinheim (Germany), 2001, 2. D. A. Knowles, Chemistry and Technology of Agrochemical Formulations, Kluwer Academic Publishers, Dordrecht, 1998 (ISBN 0-7514-0443-8), for example by extending the active compound with auxiliaries suitable for the formulation of agrochemicals, such as solvents and/or carriers, if desired emulsifiers, surfactants and dispersants, preservatives, antifoaming agents, anti-freezing agents, for seed treatment formulation also optionally colorants and/or binders and/or gelling agents.

Examples of suitable solvents are water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used.

Suitable emulsifiers are nonionic and anionic emulsifiers (for example polyoxyethylene fatty alcohol ethers, alkylsulfonates and arylsulfonates).

Examples of dispersants are lignin-sulfite waste liquors and methylcellulose.

Suitable surfactants used are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ether, ethoxylated isooctylphenol, octylphenol, nonylphenol, alkylphenol polyglycol ethers, tributylphenyl polyglycol ether, tristearylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, highly polar solvents, for example dimethyl sulfoxide, N-methylpyrrolidone or water.

Also anti-freezing agents such as glycerine, ethylene glycol, propylene glycol and bactericides such as can be added to the formulation.

Suitable antifoaming agents are for example antifoaming agents based on silicon or magnesium stearate.

Suitable preservatives are for example dichlorophen and enzylalkoholhemiformal.

Seed treatment formulations may additionally comprise binders and optionally colorants.

Binders can be added to improve the adhesion of the active materials on the seeds after treatment. Suitable binders are block copolymers EO/PO surfactants but also polyvinylalcoholsl, polyvinylpyrrolidones, polyacrylates, polymethacrylates, polybutenes, polyisobutylenes, polystyrene, polyethyleneamines, polyethyleneamides, polyethyleneimines (Lupasol®, Polymin®), polyethers, polyurethans, polyvinylacetate, tylose and copolymers derived from these polymers.

Optionally, also colorants can be included in the formulation. Suitable colorants or dyes for seed treatment formulations are Rhodamin B, C.I. Pigment Red 112, C.I. Solvent Red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers.

Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compound(s). In this case, the active compound(s) are employed in a purity of from 90% to 100% by weight, preferably 95% to 100% by weight (according to NMR spectrum).

The active compound concentrations in the ready-to-use preparations can be varied within relatively wide ranges. In general, they are from 0.0001 to 10%, preferably from 0.01 to 1% per weight.

The active compounds may also be used successfully in the ultra-low-volume process (ULV), it being possible to apply formulations comprising over 95% by weight of active compound, or even to apply the active compound without additives.

For seed treatment purposes, respective formulations can be diluted 2-10 fold leading to concentrations in the ready to use preparations of 0.01 to 60% by weight active compound by weight, preferably 0.1 to 40% by weight.

The compound(s) of formula I can be used as such, in the form of their formulations or the use forms prepared there from, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of the active compound(s) according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. However, it is also possible to prepare concentrates composed of active substance, wetter, tackifier, dispersant or emulsifier and, if appropriate, solvent or oil, and such concentrates are suitable for dilution with water.

The following are examples of formulations:

1. Products for dilution with water for foliar applications. For seed treatment purposes, such products may be applied to the seed diluted or undiluted.
A) Water-soluble concentrates (SL, LS)
10 parts by weight of the active compound(s) are dissolved in 90 parts by weight of water or a water-soluble solvent. As an alternative, wetters or other auxiliaries are added. The active compound(s) dissolves upon dilution with water, whereby a formulation with 10% (w/w) of active compound(s) is obtained.
B) Dispersible concentrates (DC)
20 parts by weight of the active compound(s) are dissolved in 70 parts by weight of cyclohexanone with addition of 10 parts by weight of a dispersant, for example polyvinylpyrrolidone. Dilution with water gives a dispersion, whereby a formulation with 20% (w/w) of active compound(s) is obtained.
C) Emulsifiable concentrates (EC)
15 parts by weight of the active compound(s) are dissolved in 7 parts by weight of xylene with addition of calcium dodecylbenzenesulfonate and castor oil ethoxylate (in each case 5 parts by weight). Dilution with water gives an emulsion, whereby a formulation with 15% (w/w) of active compound(s) is obtained.

### D) Emulsions (EW, EO, ES)

25 parts by weight of the active compound(s) are dissolved in 35 parts by weight of xylene with addition of calcium dodecylbenzenesulfonate and castor oil ethoxylate (in each case 5 parts by weight). This mixture is introduced into 30 parts by weight of water by means of an emulsifier machine (e.g. Ultraturrax) and made into a homogeneous emulsion. Dilution with water gives an emulsion, whereby a formulation with 25% (w/w) of active compound(s) is obtained.

### E) Suspensions (SC, OD, FS)

In an agitated ball mill, 20 parts by weight of the active compound(s) are comminuted with addition of 10 parts by weight of dispersants, wetters and 70 parts by weight of water or of an organic solvent to give a fine active compound(s) suspension. Dilution with water gives a stable suspension of the active compound(s), whereby a formulation with 20% (w/w) of active compound(s) is obtained.

F) Water-dispersible granules and water-soluble granules (WG, SG)

50 parts by weight of the active compound(s) are ground finely with addition of 50 parts by weight of dispersants and wetters and made as water-dispersible or water-soluble granules by means of technical appliances (for example extrusion, spray tower, fluidized bed). Dilution with water gives a stable dispersion or solution of the active compound(s), whereby a formulation with 50% (w/w) of active compound(s) is obtained.

G) Water-dispersible powders and water-soluble powders (WP, SP, SS, WS)
75 parts by weight of the active compound(s) are ground in a rotor-stator mill with addition of 25 parts by weight of dispersants, wetters and silica gel. Dilution with water gives a stable dispersion or solution of the active compound(s), whereby a formulation with 75% (w/w) of active compound(s) is obtained.

### Gel-Formulation (GF)

In an agitated ball mill, 20 parts by weight of the active compound(s) are comminuted with addition of 10 parts by weight of dispersants, 1 part by weight of a gelling agent wetters and 70 parts by weight of water or of an organic solvent to give a fine active compound(s) suspension. Dilution with water gives a stable suspension of the active compound(s), whereby a formulation with 20% (w/w) of active compound(s) is obtained.
2. Products to be applied undiluted for foliar applications. For seed treatment purposes, such products may be applied to the seed diluted.

I) Dustable powders (DP, DS)

5 parts by weight of the active compound(s) are ground finely and mixed intimately with 95 parts by weight of finely divided kaolin. This gives a dustable product having 5% (w/w) of active compound(s)

### J) Granules (GR, FG, GG, MG)

0.5 part by weight of the active compound(s) is ground finely and associated with 95.5 parts by weight of carriers, whereby a formulation with 0.5% (w/w) of active compound(s) is obtained. Current methods are extrusion, spray-drying or the fluidized bed. This gives granules to be applied undiluted for foliar use.
K) ULV solutions (UL)
10 parts by weight of the active compound(s) are dissolved in 90 parts by weight of an organic solvent, for example xylene. This gives a product having 10% (w/w) of active compound(s), which is applied undiluted for foliar use.

Conventional seed treatment formulations include for example flowable concentrates FS, solutions LS, powders for dry treatment DS, water dispersible powders for slurry treatment WS, water-soluble powders SS and emulsion ES and EC and gel formulation GF. These formulations can be applied to the seed diluted or undiluted. Application to the seeds is carried out before sowing, either directly on the seeds.

In a preferred embodiment a FS formulation is used for seed treatment. Typically, a FS formulation may comprise 1-800 g/l of active ingredient, 1-200 g/l Surfactant, 0 to 200 g/l antifreezing agent, 0 to 400 g/l of binder, 0 to 200 g/l of a pigment and up to 1 litre of a solvent, preferably water.

Various types of oils, wetters, adjuvants, herbicides, fungicides, other pesticides, or bactericides may be added to the active compounds, if appropriate not until immediately prior to use (tank mix). These agents can be admixed with the agents according to the invention in a weight ratio of 1:100 to 100:1, preferably 1:10 to 10:1.

Suitable adjuvants in this sense are in particular: organically modified polysiloxanes, for example Break Thru S 240®; alcohol alkoxylates, for example Atplus 245®, Atplus MBA 1303®, Plurafac LF 300® and Lutensol ON 30®; EO/PO block polymers, for example Pluronic RPE 2035® and Genapol B®; alcohol ethoxylates, for example Lutensol XP 80®; and sodium dioctylsulfosuccinate, for example Leophen RA®.

The following examples are intended to illustrate the invention, but without imposing any limitation.

### EXAMPLES

Field trials were conducted as strip trials in farm fields in 2006 and 2008. A part of the field was treated with pyraclostrobin applied as Headline® whereas another part was left untreated. Headline® was applied at tassel emergence with 0.44 L/ha (110 g pyraclostrobin per ha) by aerial or ground application with a high clearance sprayer. Total spray volume was 93.5 to 187 L/ha for ground application and 18.7 to 46.7 L/ha for aerial application, respectively. Water was used as a carrier to prepare the spray mixture.

Trials were harvested using a commercial forage harvester when the corn crop reached a dry matter content of about 30 to 40%. The treated and untreated area of the field was harvested separately to gain total biomass yield (ton/acre). Subsequently, the harvested plant material was used for producing silage.

Forage samples from the harvested plants were taken from both the treated and untreated areas of the field. Samples were taken from the harvested material in the forage wagon following chopping with the commercial harvester. Multiple forage samples were taken for each of both treatments manually during harvesting in each of the trials, mixed in a larger container, and a subsample of 1.3 to 2.25 kg was taken. The subsamples were placed in plastic bags, sealed, cooled, and shipped immediately to Agsource Soil and Forage Laboratory, 106 North Cecil Street, Bonduel Wis. 54107, USA for Near Infrared Reflectance Spectroscopy (NIRS) analysis.

Typically, samples for NIRS analysis are first dried at 55 to 65° C. for 24 h to 48 h prior to analysis. A representative subsample thereof is then dried at 105° C. for another 12 h to 24 h to evaluate the dry matter content of the samples. Subsequently, the remaining sample is grinded and homogenized and again a representative subsample is used for the NIRS analysis. The NIRS analysis procedure uses a commercially available calibration to estimate the values for each quality parameter based on the spectral reflectance information gained. The calibrations are based on the near infra red reflectance spectra of samples with known quality data. The comparison of the spectra of the samples with unknown quality data with the spectra of the known samples allows calculating estimates for each quality parameter of interest.

NIRS analysis provided dry matter, crude protein, Acid Detergent Fibre (ADF), Neutral Detergent Fibre (NDF), and starch data. Calculations were included for moisture, adjusted crude protein, Total Digestible Nutrients (TDN), Net Energy for Lactation (NEL), Net Energy for Gain (NEG) and protein solubility.

The information was then entered into the MILK 2006 University of Wisconsin Corn Silage evaluation system. Calculations of the milk production, energy content and digestibility per ton of corn biomass were carried out using a calculation method described in:

a) Schwab, E. C., and R. D. Shaver. 2001: “Evaluation of corn silage nutritive value using MILK2000” (pages 21-24) in Proc. of 25th Forage Production and Use Symposium. WI Forage Council Annual Mtg. Eau Claire, Wis.
b) Schwab, E. C., R. D. Shaver. J. G. Lauer, and J. G. Coors. 2003: “Estimating silage energy value and milk yield to rank corn hybrids”. J. Anim. Feed Sci. Technol. 109: 1-18. as well as in
c) Undersander, D. J., W. T. Howard, and R. D. Shaver. 1993: “Milk per acre spreadsheet for combining yield and quality into a single term”. J. Prod. Ag. 6: 231 235.

### Example 1

### Maryland 2006

In 2006 a total of 16 strip trials were conducted in Queen Ann County, MD. Trial setup, treatments, application, harvesting, sampling and quality analysis including calculation of milk production per ton and per acre followed the procedure described before. Quality data of harvested biomass and milk production is shown in table VIII.

TABLE VIII
Average values for crude protein content (% CP), neutral detergent fiber
content (% NDF), in vitro 48-hour digestible NDF expressed as percent
of NDF (% NDFD), starch content (% starch), total digestible nutrients
as percent of dry matter (TDN % of DM), and the calculated value for
milk produced per ton of silage (Milk (kg/t).

| | | % | | | TDN % | Milk |
|---|---|---|---|---|---|---|
| Treatment | % CP | NDF | % NDFD | % Starch | of DM | (kg/t) |
| Untreated | 6.7 | 48.2 | 58.3 | 25.6 | 67.6 | 1634 |
| Pyraclostrobin | 7.1 | 45.9 | 60.6 | 28.2 | 70.0 | 1730 |
| % Difference | +6.0 | −4.8 | +3.9 | +10.2 | +3.6 | +5.9 |
| to Untreated | | | | | | |

As can be seen in table VIII, pyraclostrobin treatment increased the digestibility (% NDFD by +3.9%; TDN % of DM by +3.6%), the energy content (% NDF by −4.8% (a decrease in % NDF results in an increase of energy content); Starch by +10.2%) and the calculated milk production per ton of silage by +5.9%.

### Example 2

### Wisconsin 2006

In 2006 a total of 7 strip trials were conducted in Manitowoc County, Wis. Trial setup, treatments, application, harvesting, sampling and quality analysis including calculation of milk production per ton and per acre followed the procedure described before. Quality data of harvested biomass and milk production is shown in table IX.

TABLE IX
Average values for crude protein content (% CP), acid detergent
fiber content (% ADF), neutral detergent fiber content (% NDF),
in vitro 48-hour digestible NDF expressed as percent of NDF
(% NDFD), starch content (% starch), total digestible nutrients
as percent of dry matter (TDN % of DM), and the calculated
value for milk produced per ton of silage (Milk (kg/t).

| | | | | | % | Milk |
|---|---|---|---|---|---|---|
| Treatment | % CP | % ADF | % NDF | % NDFD | Starch | (kg/t) |
| Untreated | 7.2 | 26.5 | 45.6 | 59.7 | 32.9 | 1592 |
| Pyraclostrobin | 7.5 | 22.2 | 39.5 | 67.6 | 37.4 | 1815 |
| % Difference | +4.2 | −16.2 | −13.4 | +13.2 | +13.7 | +14.0 |
| to Untreated | | | | | | |

As can be seen in table IX, pyraclostrobin treatment increased the digestibility (% NDFD by +13.2%; ADF by −16.2% (a decrease in ADF results in an increase in digestibility)), the energy content (% NDF by −13.4% (a decrease in % NDF results in an increase of energy content); Starch by +13.7%) and the calculated milk production per ton of silage by +14.0%.

### Example 3

### New York 2006

In 2006 a total of 2 strip trials were conducted in Waterloo, N.Y. Trial setup, treatments, application, harvesting, sampling and quality analysis including calculation of milk production per ton and per acre followed the procedure described before. Quality data of harvested biomass and milk production is shown in table X.

TABLE X
Average values for dry matter content, crude protein content (% CP),
neutral detergent fiber content (% NDF), in vitro 48-hour digestible
NDF expressed as percent of NDF (% NDFD), starch content
(% starch), total digestible nutrients as percent of dry matter
(TDN % of DM), and the calculated value for milk produced
per ton of silage (Milk (kg/t).

| | % Dry | | | | % | Milk |
|---|---|---|---|---|---|---|
| Treatment | Matter | % CP | % NDF | % NDFD | Starch | (kg/t) |
| Untreated | 37.28 | 6.15 | 45.92 | 43.00 | 36.78 | 1364 |
| Pyraclostrobin | 36.45 | 6.52 | 38.18 | 51.30 | 42.42 | 1653 |
| % Difference | −2.2 | +6.0 | −16.8 | +19.3 | +15.3 | +21.2 |
| to Untreated | | | | | | |

As can be seen in table X, pyraclostrobin treatment increased the digestibility (% NDFD by +19.3%), the energy content (% NDF by −16.8% (a decrease in % NDF results in an increase of energy content); Starch by +15.3%) and the calculated milk production per ton of silage by +21.2%.

### Example 4

### Wisconsin 2008

Eight different corn hybrid varieties were tested in a field trial in Unity, Wis., in 2008. Trial setup, application, harvesting, sampling and quality analysis including calculation of milk production per ton followed the procedure described before. Each hybrid was either treated with pyraclostrobin as described before or untreated. The quality data was converted into milk production per ton of harvested biomass for each hybrid as described above.

TABLE XI
Calculated milk production for different corn hybrids treated or
not treated with pyraclostrobin.

| | | | Milk | % Difference |
|---|---|---|---|---|
| Example | Hybrid | Treatment | (kg/t) | to Untreated |
| 4.1 | DS93VT3 | Untreated | 1467 | |
| | DS93VT3 | Pyraclostrobin | 1608 | +9.6 |
| 4.2 | S4900VT | Untreated | 1345 | |
| | S4900VT | Pyraclostrobin | 1581 | +17.5 |
| 4.3 | 3114VT3 | Untreated | 1538 | |
| | 3114VT3 | Pyraclostrobin | 1648 | +7.1 |
| 4.4 | 491VT3 | Untreated | 1481 | |
| | 491VT3 | Pyraclostrobin | 1643 | +10.9 |
| 4.5 | N27B | Untreated | 1269 | |
| | CBLLRW | | | |
| | N27B | Pyraclostrobin | 1549 | +22.0 |
| | CBLLRW | | | |
| 4.6 | DS93VT3 | Untreated | 1323 | |
| | DS93VT3 | Pyraclostrobin | 1600 | +20.9 |
| 4.7 | DKC48-37 | Untreated | 1548 | |
| | DKC48-37 | Pyraclostrobin | 1684 | +8.8 |
| 4.8 | DS93VT3 | Untreated | 1508 | |
| | DS93VT3 | Pyraclostrobin | 1632 | +8.3 |

The data shows that the strobilurin pyraclostrobin improves the milk production per ton of harvested corn biomass used to produce silage for feeding across the eight tested different corn hybrids independent of the genetic background.

As was shown in the presented examples, the corn used to produce silage for feeding is improved in key quality parameters like protein content, starch content, fiber content, digestibility and energy content. Hence, the nutritional value of forage that is treated with pyraclostrobin and that is used for ensiling is improved resulting in more milk produced per ton of forage or silage, respectively.

1-15. (canceled)

16. A method of increasing the quantity of milk or meat produced by a milk-producing animal or a meat-producing animal comprising:
a) applying at least one strobilurin compound to a plant, a propagule, or a site where the plant is growing or is to grow;
b) producing silage from the plant;
c) feeding the milk-producing animal or the meat-producing animal the silage made from the plant.

17. The method of claim 16, wherein the at least one strobilurin compound is of formula I 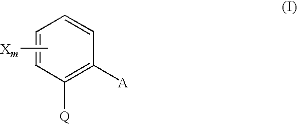
wherein:
X is halogen, C₁-C₄-alkyl or trifluoromethyl;
m is 0 or 1;
Q is C(═CH—CH₃)—COOCH₃, C(═CH—OCH₃)—COOCH₃, C(═N—OCH₃)—CONHCH₃, C(═N—OCH₃)—COOCH₃, N(—OCH₃)—COOCH₃, or the group Q1 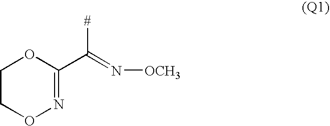
where # denotes the bond to the phenyl ring;
A is —O—B, —CH₂O—B, —OCH₂—B, —CH₂S—B, —CH═CH—B, —CH₂O—N═C(R¹)—B, —CH₂S—N═C(R¹)—B, —CH₂O—N═C(R¹)—CH═CH—B, or —CH₂O—N═C(R¹)—C(R²)═N—OR³, wherein
B is phenyl, naphthyl, 5- or 6-membered heteroaryl or 5- or 6-membered heterocyclyl which contains one, two or three nitrogen atoms and/or one oxygen or sulfur atom, or one or two oxygen and/or sulfur atoms, wherein the ring systems are unsubstituted or substituted by one, two or three groups R^{a}; wherein
R^{a} are independently of each other cyano, nitro, amino, aminocarbonyl, aminothiocarbonyl, halogen, C₁-C₆-alkyl, C₁-C₆-haloalkyl, C₁-C₆-alkylcarbonyl, C₁-C₆-alkylsulfonyl, C₁-C₆-alkylsulfinyl, C₃-C₆-cycloalkyl, C₁-C₆-alkoxy, C₁-C₆-haloalkoxy, C₁-C₆-alkyloxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylaminothiocarbonyl, di-C₁-C₆-alkylaminothiocarbonyl, C₂-C₆-alkenyl, C₂-C₆-alkenyloxy, phenyl, phenoxy, benzyl, benzyloxy, 5- or 6-membered heterocyclyl, 5- or 6-membered heteroaryl, 5- or 6-membered heteroaryloxy, C(═NOR′)—R″ or OC(R′)₂—C(R″)═NOR″, wherein the cyclic groups for their part may be unsubstituted or substituted by one, two, three, four or five groups R^{b}:
R^{b} are independently of each another cyano, nitro, halogen, amino, aminocarbonyl, aminothiocarbonyl, C₁-C₆-alkyl, C₁-C₆-haloalkyl, C₁-C₆-alkylsulfonyl, C₁-C₆-alkylsulfinyl, C₃-C₆-cycloalkyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylaminothiocarbonyl, di-C₁-C₆-alkylaminothiocarbonyl, C₂-C₆-alkenyl, C₂-C₆-alkenyloxy, C₃-C₆-cycloalkyl, C₃-C₆-cycloalkenyl, phenyl, phenoxy, phenylthio, benzyl, benzyloxy, 5- or 6-membered heterocyclyl, 5- or 6-membered heteroaryl, 5- or 6-membered heteroaryloxy or C(═NOR′)—R″;
R′, R″ are independently of one another hydrogen or C₁-C₆-alkyl;
R¹ is hydrogen, cyano, C₁-C₄-alkyl, C₁-C₄-haloalkyl, C₃-C₆-cycloalkyl, C₁-C₄-alkoxy, or C₁-C₄-alkylthio;
R² is phenyl, phenylcarbonyl, phenylsulfonyl, 5- or 6-membered heteroaryl, 5- or 6-membered heteroarylcarbonyl or 5- or 6-membered heteroarylsulfonyl, wherein the ring systems are unsubstituted or substituted by one, two, three, four or five groups R^{a}, C₁-C₁₀-alkyl, C₃-C₆-cycloalkyl, C₂-C₁₀-alkenyl, C₂-C₁₀-alkynyl, C₁-C₁₀-alkylcarbonyl, C₂-C₁₀-alkenylcarbonyl, C₃-C₁₀-alkynylcarbonyl, C₁-C₁₀-alkylsulfonyl or C(═NOR′)—R″, where the carbon chains may be unsubstituted or substituted by one, two, three, four or five groups R^{c}:
R^{c} are independently of each other another are cyano, nitro, amino, aminocarbonyl, aminothiocarbonyl, halogen, C₁-C₆-alkyl, C₁-C₆-haloalkyl, C₁-C₆-alkylsulfonyl, C₁-C₆-alkylsulfinyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylaminothiocarbonyl, di-C₁-C₆-alkylaminothiocarbonyl, C₂-C₆-alkenyl, C₂-C₆-alkenyloxy, C₃-C₆-cycloalkyl, C₃-C₆-cycloalkyloxy, 5- or 6-membered heterocyclyl, 5- or 6-membered heterocyclyloxy, benzyl, benzyloxy, phenyl, phenoxy, phenylthio, 5- or 6-membered heteroaryl, 5- or 6-membered heteroaryloxy or heteroarylthio, wherein the cyclic groups may be partially or fully halogenated or may be substituted by one, two or three groups R^{a}; and
R³ is hydrogen, C₁-C₆-alkyl, C₂-C₆-alkenyl, or C₂-C₆-alkynyl, where the carbon chains may be substituted by one, two, three, four or five groups le;
and their agricultural useful salts.

18. The method of claim 16, wherein the strobilurin compound is selected from the group consisting of methyl (2-chloro-5-[1-(3-methylbenzyloxyimino)ethyl]benzyl)carbamate, methyl (2-chloro-5-[1-(6-methylpyridin-2-ylmethoxyimino)ethyl]benzyl)carbamate, 2-(2-(6-(3-chloro-2-methyl-phenoxy)-5-fluoro-pyrimidin-4-yloxy)-phenyl)-2-methoxy-imino-N-methyl-acetamide and 3-methoxy-2-(2-(N-(4-methoxy-phenyl)cyclo-propane-carboximidoyl-sulfanyl-methyl)-phenyl)acrylic acid methyl ester.

19. The method of claim 16, wherein at least one strobilurin compound is pyraclostrobin, kresoxim-methyl, dimoxystrobin, (E)-2-[2-(2,5-Dimethyl-phenoxymethyl)-phenyl]-3-methoxy-acrylic acid methyl ester (ZJ 0712), picoxystrobin, trifloxystrobin, enestroburin, orysastrobin, metominostrobin, azoxystrobin or fluoxastrobin.

20. The method of claim 16, wherein at least one strobilurin compound is pyraclostrobin or kresoxim-methyl.

21. The method of claim 16, wherein at least one strobilurin compound is used together with a second active compound.

22. The method of claim 16, wherein the plant or the propagule is selected from the group consisting of maize, grass, clovers, sorghum, oat, rye, vetches, alfalfa, grass mixes and weeds.

23. The method of claim 16, wherein the at least one strobilurin compound is pyraclostrobin and wherein the plant is maize.

24. The method of claim 16, wherein the at least one strobilurin compound is kresoxim-methyl and wherein the plant is maize.

25. The method of claim 16, wherein the at least one strobilurin compound is applied to a propagule, and wherein the propagule is a seed.

26. The method of claim 16, wherein the milk-producing animal or the meat-producing animal is selected from the group consisting of cattle, sheep, swine, horses and goats.

27. The method of claim 16, wherein the increase in milk quantity of the milk-producing animal is at least 3%.

28. Silage for feeding animals, produced from a plant treated with at least one strobilurin compound prior to producing said silage, wherein said silage displays an increased energy content.

29. The silage of claim 28, wherein said silage displays an enhanced digestibility.

30. Silage for feeding animals, produced from a plant treated with at least one strobilurin compound prior to producing said silage, wherein said silage displays an increased energy content; and wherein the at least one strobilurin compound is of formula I 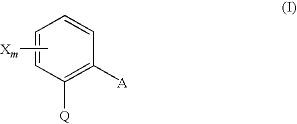
wherein:
X is halogen, C₁-C₄-alkyl or trifluoromethyl;
m is 0 or 1;
Q is C(═CH—CH₃)—COOCH₃, C(═CH—OCH₃)—COOCH₃, C(═N—OCH₃)—CONHCH₃, C(═N—OCH₃)—COOCH₃, N(—OCH₃)—COOCH₃, or the group Q1 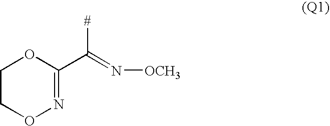
where # denotes the bond to the phenyl ring;
A is —O—B, —CH₂O—B, —OCH₂—B, —CH₂S—B, —CH═CH—B, —CH₂O—N═C(R¹)— B, —CH₂S—N═C(R¹)—B, —CH₂O—N═C(R¹)—CH═CH—B, or —CH₂O—N═C(R¹)—C(R²)═N—OR³, wherein
B is phenyl, naphthyl, 5- or 6-membered heteroaryl or 5- or 6-membered heterocyclyl which contains one, two or three nitrogen atoms and/or one oxygen or sulfur atom, or one or two oxygen and/or sulfur atoms, wherein the ring systems are unsubstituted or substituted by one, two or three groups R^{a}; wherein
R^{a} are independently of each other cyano, nitro, amino, aminocarbonyl, aminothiocarbonyl, halogen, C₁-C₆-alkyl, C₁-C₆-haloalkyl, C₁-C₆-alkylcarbonyl, C₁-C₆-alkylsulfonyl, C₁-C₆-alkylsulfinyl, C₃-C₆-cycloalkyl, C₁-C₆-alkoxy, C₁-C₆-haloalkoxy, C₁-C₆-alkyloxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylaminothiocarbonyl, di-C₁-C₆-alkylaminothiocarbonyl, C₂-C₆-alkenyl, C₂-C₆-alkenyloxy, phenyl, phenoxy, benzyl, benzyloxy, 5- or 6-membered heterocyclyl, 5- or 6-membered heteroaryl, 5- or 6-membered heteroaryloxy, C(═NOR′)—R″ or OC(R′)₂—C(R″)═NOR″, wherein the cyclic groups for their part may be unsubstituted or substituted by one, two, three, four or five groups R^{b}:
R^{b} are independently of each another cyano, nitro, halogen, amino, aminocarbonyl, aminothiocarbonyl, C₁-C₆-alkyl, C₁-C₆-haloalkyl, C₁-C₆-alkylsulfonyl, C₁-C₆-alkylsulfinyl, C₃-C₆-cycloalkyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylaminothiocarbonyl, di-C₁-C₆-alkylaminothiocarbonyl, C₂-C₆-alkenyl, C₂-C₆-alkenyloxy, C₃-C₆-cycloalkyl, C₃-C₆-cycloalkenyl, phenyl, phenoxy, phenylthio, benzyl, benzyloxy, 5- or 6-membered heterocyclyl, 5- or 6-membered heteroaryl, 5- or 6-membered heteroaryloxy or C(═NOR′)—R″;
R′, R″ are independently of one another hydrogen or C₁-C₆-alkyl;
R¹ is hydrogen, cyano, C₁-C₄-alkyl, C₁-C₄-haloalkyl, C₃-C₆-cycloalkyl, C₁-C₄-alkoxy, or C₁-C₄-alkylthio;
R² is phenyl, phenylcarbonyl, phenylsulfonyl, 5- or 6-membered heteroaryl, 5- or 6-membered heteroarylcarbonyl or 5- or 6-membered heteroarylsulfonyl, wherein the ring systems are unsubstituted or substituted by one, two, three, four or five groups R^{a},C₁-C₁₀-alkyl, C₃-C₆-cycloalkyl, C₂-C₁₀-alkenyl, C₂-C₁₀-alkynyl, C₁-C₁₀-alkylcarbonyl, C₂-C₁₀-alkenylcarbonyl, C₃-C₁₀-alkynylcarbonyl, C₁-C₁₀-alkylsulfonyl or C(═NOR′)—R″, where the carbon chains may be unsubstituted or substituted by one, two, three, four or five groups R^{c}:
R^{c} are independently of each other another cyano, nitro, amino, aminocarbonyl, aminothiocarbonyl, halogen, C₁-C₆-alkyl, C₁-C₆-haloalkyl, C₁-C₆-alkylsulfonyl, C₁-C₆-alkylsulfinyl, C₁-C₆-alkoxy, C₁-Cₒ-haloalkoxy, C₁-C₆-alkoxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylaminothiocarbonyl, di-C₁-C₆-alkylaminothiocarbonyl, C₂-C₆-alkenyl, C₂-C₆-alkenyloxy, C₃-C₆-cycloalkyl, C₃-C₆-cycloalkyloxy, 5- or 6-membered heterocyclyl, 5- or 6-membered heterocyclyloxy, benzyl, benzyloxy, phenyl, phenoxy, phenylthio, 5- or 6-membered heteroaryl, 5- or 6-membered heteroaryloxy or heteroarylthio, wherein the cyclic groups may be partially or fully halogenated or may be substituted by one, two or three groups R^{a}; and
R³ is hydrogen, C₁-C₆-alkyl, C₂-C₆-alkenyl, C₂-C₆-alkynyl, where the carbon chains may be substituted by one, two, three, four or five groups R^{c};
and their agricultural useful salts.

31. The silage of claim 30, wherein said silage displays an enhanced digestibility.
